(19) United States
(12) Patent Application Publication
(10) Pub. No.: US 2018/0001460 A1
(43) Pub. Date: Jan. 4, 2018

(54) DEVICE FOR APPLYING RAILROAD ANCHORS

(71) Applicant: Daniel Ray Foucault, Nuagara Falls (CA)

(72) Inventor: Daniel Ray Foucault, Nuagara Falls (CA)

(21) Appl. No.: 15/199,778

(22) Filed: Jun. 30, 2016

(51) Int. Cl. B25D 1/14; B25G 1/10

(52) U.S. Cl. CPC B25D 1/14; B25G 1/102; E01B 2201/00

(57) ABSTRACT

A device for re-securing or applying railroad anchors for improving the efficiency of a railroad worker. The disclosure provides a means for clearing railroad ballast and driving an anchor spike, in a single combined tool. The disclosure describes a device for applying railroad anchors including a hammer head and a handle. The device for applying railroad anchors includes a hammer head having a first end and a second end. The first end is formed as a sledge hammer for driving railroad anchors. The second end is formed as a railroad spike maul shape for clearing ballast.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of tools and more specifically relates to a device for re-securing or applying railroad anchors.

### 2. Description of Related Art

The railroad industry has a long history. Many formerly manual activities have since been replaced with machinery and automation. While generally more efficient, reliance on automation may result in a decrease manual skillsets.

Railroad maintenance is an ongoing process. Even with the increase in technology and automated tool use, there exists a necessity to manually walk the rails and manually make spot repairs. This requirement is especially true in the case of individual rail anchors that are loose. Railroad anchors are clips that attach to the underside of the rail and are mounted to the railroad ties with spikes to prevent the rail from moving side-to-side. Loose anchors are often discovered by workers walking the line. Workers then re-drive the spikes to fasten the anchors in more securely, increasing overall rail safety. Driving the spikes (re-securing the anchors) requires a special hammer having a handle and a balanced head. The spike maul, also known as a spiking hammer, is a type of sledgehammer with a long thin head that was originally used to drive spikes. Now you have to use a sledge hammer with a long handle. This hammer is a better tool to apply anchors, however, it lacks the added utility of the narrow spike maul end in the older equipment.

Often times, railroad ballast covers the anchors and their respective spikes. Railroad or track ballast forms the trackbed upon which railroad ties are laid. It is packed between, below, and around the ties. It is used to bear the load from the railroad ties, to facilitate drainage of water, and also to keep down vegetation that might interfere with the track structure. This also serves to hold the track in place as the trains roll by. It is typically made of crushed stone, although ballast has sometimes consisted of other, less suitable materials.

While ballast may make it easier to spot rogue loose anchors (i.e., discovered by viewing spikes that protrude through the ballast), to drive the spikes, the ballast must first be cleared. Otherwise, the sledge hammer will hit the ballast rocks instead of, or in addition to, hitting the rail spike. In the past a spike maul had the auxiliary benefit of clearing ballast.

Currently, clearing the anchors requires a special, dedicated tool sincerailroad workers are no longer allowed to use the former improvised clearing tool (spike maul) in order to drive anchors. Accordingly separate heavy duty tools are required. In addition, separate workers may be required whereas each worker carries the appropriate tool, one for moving the ballast, and another tool for driving the anchor. This is an inefficient process. Therefore, a better solution is desirable.

Several attempts have been made to solve the above-mentioned problems such as those found in U.S. Pat No. 7,168,339 to Nau, U.S. Pat No. 6,829,966 to Bramuchi, Pat No. CN104480813 to Mountain and Zhiqiang, Pat No. CN2126855 to Halishak, and Pat No. CN203212955 to Hutchison and Marks. This art is representative of tools. However, none of the above inventions and patents, taken either singly or in combination, is seen to describe the invention as claimed.

Preferably, a device for applying railroad anchors should provide a suitable solution for clearing ballast and driving an anchor and, yet would operate reliably and be manufactured at a modest expense. Thus, a need exists for a reliable device for applying railroad anchors to avoid the above-mentioned problems.

### BRIEF SUMMARY OF THE INVENTION

In view of the foregoing disadvantages inherent in the known tools art, the present invention provides a novel device for applying railroad anchors. The general purpose of the present invention, which will be described subsequently in greater detail is to provide a means for clearing railroad ballast and driving an anchor in a combined tool.

Disclosed herein is a device for applying railroad anchors comprising a hammer head and a handle for the purpose of combining two railroad maintenance functions into a single tool. The device for applying railroad anchors includes a hammer head having a first end and a second end. The first end is formed as a sledge hammer for driving railroad anchors. The second end is generally formed as a railroad spike maul, but configured for clearing ballast. The hammer head may be composed of steel to provide sufficient striking weight. The second end may be approximately six inches long and have a polygonal cross-sectional shape.

The handle material may comprise wood, such that the device for applying railroad anchors is lightweight. The handle may be approximately three feet long and may include a texture for gripping.

The device for applying railroad anchors can be sold as a kit including a set of instructions. Also disclosed is a method of using a device for applying railroad anchors comprising the steps of obtaining the device for applying railroad anchors, clearing ballast away from a railroad anchor with the device for applying railroad anchors, and driving the rail road anchor with the device for applying railroad anchors.

The present invention holds significant improvements and serves as a method for increasing the efficiency of railroad workers. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and method(s) of use for the present invention, device for applying railroad anchors, constructed and operative according to the teachings of the present invention.

FIG. 1 shows a perspective view illustrating a device for applying railroad anchors during an ‘in-use’ condition, showing a clearing use of one end of its head, according to an embodiment of the present disclosure.

FIG. 2 is a perspective view illustrating the device of FIG. 1 during an ‘in-use’ condition, showing a driving use of the other end of its head, according to an embodiment of the present disclosure.

FIG. 3 is a perspective view illustrating a device of FIGS. 1-2, according to an embodiment of the present disclosure

FIG. 4 is a perspective view illustrating multiple variants of the device of FIGS. 1-3, according to embodiments of the present disclosure.

FIG. 5 is a flowchart illustrating a method of use for device for applying railroad anchors of FIGS. 1-4, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present invention relate to tools and more particularly to a device for applying railroad anchors as used to improve the efficiency of a railroad worker.

Generally speaking, device for applying railroad anchors increases the efficiency of railroad maintenance by combining two functions (and two tools) into a single tool. Here, the first function is clearing ballast, and the second function is driving spike/securing an anchor.

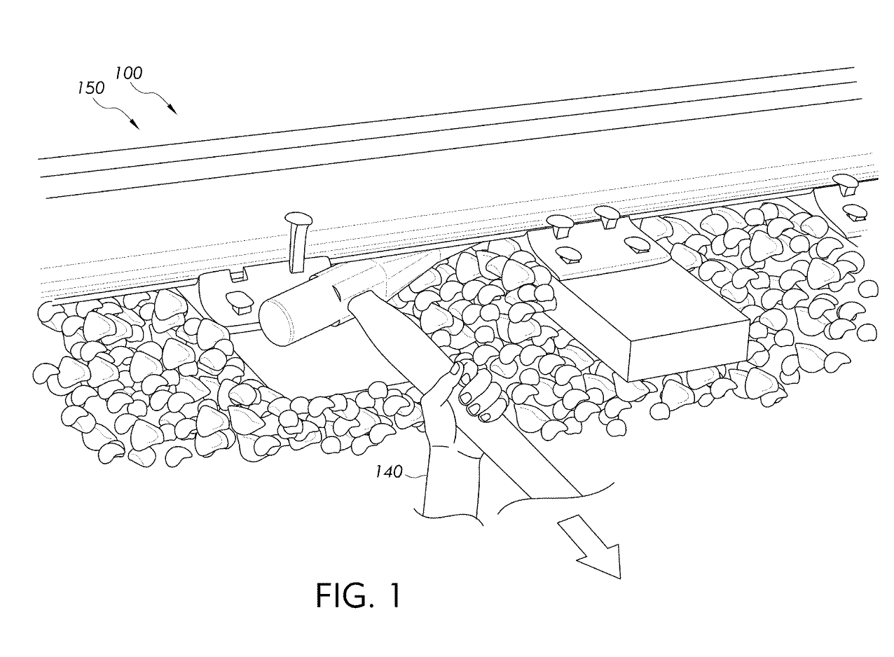

Referring to the drawings by numerals of reference there is shown in FIG. 1, a device for applying railroad anchors 100 during an ‘in-use’ condition 150 by user 140 while clearing ballast. In particular, the user 140 of FIGS. 1-4 is shown being used manipulating (in the direction shown) the ballast (stones) that are covering the rail anchor (the stones are removed from beneath the track, used to remove ballast or rock from under the rail, with the narrow spike maul end, while the sledge hammer side applies the anchor). The anchor binds the rail to the tie to stop the rail from growing when it's hot, or shrinking when it's too cold.

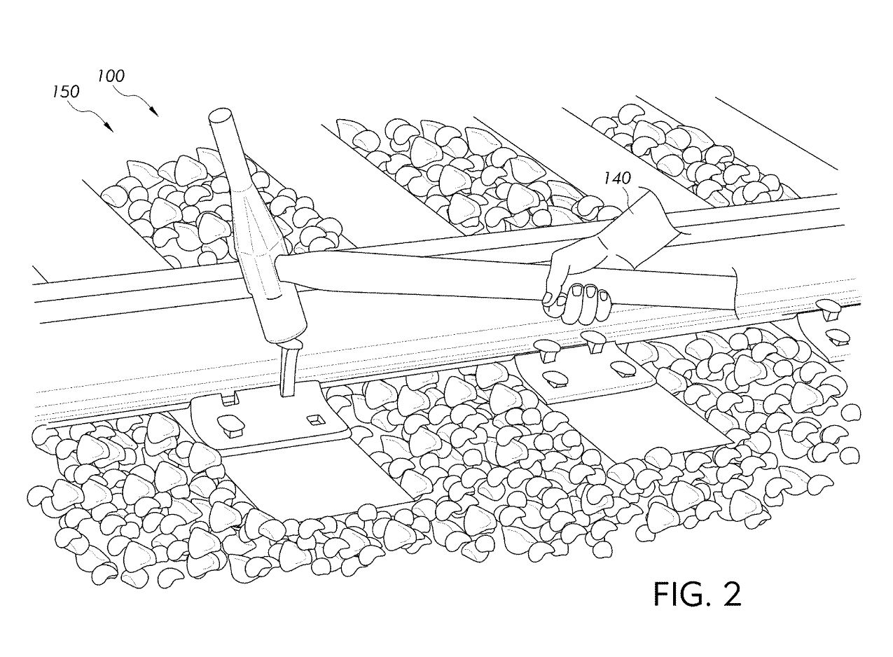

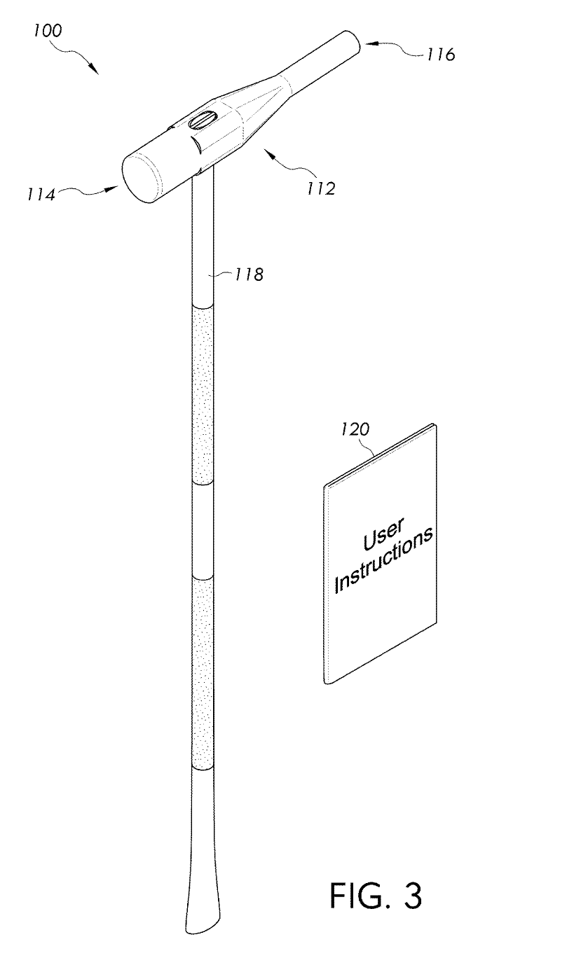

Referring now to FIGS. 2-3, a device for applying railroad anchors 100 may include a hammer head 112 and a handle 118. The hammer head 112 comprises a first end 114 and a second end 116. The first end 114 may generally be formed as half of a sledge hammer, and a second end 116 may generally be formed as half of a spike maul. Notwithstanding having significantly different halves, the first end 114 and the second end 116 may be sized and weighted such that the hammer head 112 may be balanced about the handle 118. Advantageously, a single user may have the primary hammering utility of the sledge hammer end, combined with the spike maul end, without compromising the integrity of the hammer head 112 as a hammer.

In the preferred embodiment, the hammer handle 118 may be made of wood. This may provide adequate functionality along with the dual benefit of being lightweight and inexpensive. In alternate embodiments handle 118 material may be comprised of another lightweight material (such as fiberglass), a more durable material (such as steel), a composite/advanced material, or any combination thereof.

According to one embodiment, hammer handle 118 may be approximately three feet long. In alternate embodiments, hammer handle 118 may be one to four feet long. In yet another embodiment the handle 118 may include a texture for gripping. For example, the handle 118 may include a rubber sleeve for gripping, or as shown a plurality of sections having strategically placed grip surfaces (e.g., for each hand or for each mode of use).

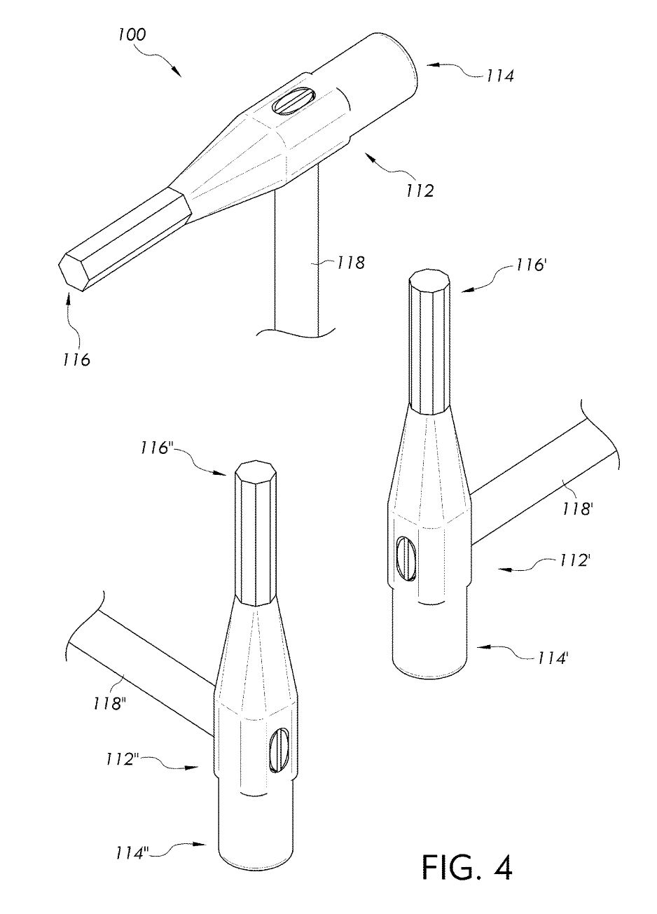

Referring now to FIG. 4, various embodiments of the device for applying railroad anchors 100 are shown. As above, the device 100 may comprise a hammer head 112 with a spike maul end (second end 116). While above the spike maul was shown having a round cross-section, the spike maul end may alternately have a cross-section that is circular in shape, as illustrated. In alternate embodiments, the second end 116′, 116″ can be octagonal or decagonal in shape, respectively. Benefits of the polygonal cross-sections may include providing a sharper edge and improved performance It is understood that additional shapes are contemplated and may include transitionary regions between the first end 114 and the second end 116 second end 116, which may be further modified, for example to interface with handle 118 or to balance each end.

It should be noted that a device for applying railroad anchors 100 may be arranged as kit comprising the following parts: at least one device for applying railroad anchors 100 and at least one set of user instructions 120 (FIG. 3). The kit has instructions 120 such that functional relationships are detailed in relation to the structure of the invention (such that the invention can be used, maintained, or the like in a preferred manner). Device for applying railroad anchors 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

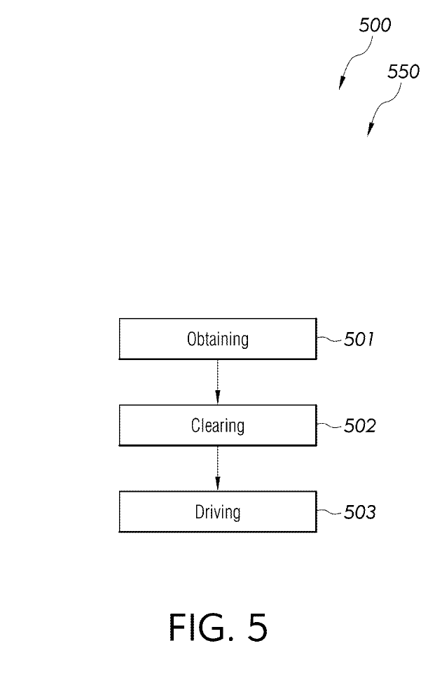

Referring now to FIG. 5 showing flowchart 550 illustrating method of use 500 for device for applying railroad anchors 100 according to an embodiment of the present invention of FIGS. 1-4. As shown, method of use 500 may comprise the steps of: step one 501, obtaining a device for applying railroad anchors 100, step two 502, clearing ballast with the second end 116, and step three 503, driving a railroad anchor with the first end 114.

It should be noted that the steps described in the method of use can be carried out in many different orders according to user preference. The use of “step of” should not be interpreted as “step for”, in the claims herein and is not intended to invoke the provisions of 35 U.S.C. §112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for applying railroad anchors, the device comprising:
a hammer head having;
a first end configured as a sledge hammer;
a second end configured as a railroad spike maul; and
a handle;
wherein said hammer head and said handle are in structural and functional combination, and are configured for driving railroad spikes with said first end and clearing railroad ballast with said second end.

2. The device of claim 1, wherein said hammer head is composed of steel.

3. The device of claim 2, wherein said handle is composed of fiberglass.

4. The device of claim 2, wherein said handle is composed of wood.

5. The device of claim 1, wherein said handle is made of steel.

6. The device of claim 1, wherein said handle is between 33 inches and 39 inches.

7. The device of claim 1, wherein said handle is at least three feet long.

8. The device of claim 1, wherein said handle is one to four feet long.

9. The device of claim 1, wherein said handle includes a texture for gripping.

10. The device of claim 1, wherein said handle includes a rubber sleeve for gripping.

11. The device of claim 1, wherein said second end is approximately six inches long.

12. The device of claim 1, wherein said second end is circular in shape.

13. The device of claim 1, wherein said second end is octagonal in shape.

14. The device of claim 1, wherein said second end is decagonal in shape.

15. The device of claim 1, wherein said second end is between three inches and six inches long.

16. The device of claim 1, wherein said second end is at least six inches long.

17. A railroad anchor maul system comprising:
a hammer head having
a first end configured as a sledge hammer; and
a second end configured to rake track ballast; and
a handle;
wherein said hammer head and said handle are in structural and functional combination, and are configured as a device for re-securing railroad anchors via clearing railroad ballast with said second end and driving railroad anchor spikes with said first end;
wherein said hammer head is composed of steel;
wherein said handle is composed of wood;
wherein said handle is between 33 inches and 39 inches;
wherein said handle includes a texture for gripping;
wherein said second end is six inches long; and
wherein said second end is circular in shape.

18. The railroad anchor maul system of claim 17, further comprising a set of instructions; and
wherein, together, said device for applying railroad anchors and the set of instructions are arranged as a kit.

19. A method for re-securing a railroad anchor, the method comprising the steps of:
providing a device for applying railroad anchors, said device including a hammer head having a first end configured as a sledge hammer and a second end configured as a spike maul, said device further including a handle in structural and functional combination with the hammer head;
clearing ballast away from a railroad anchor with the second end of the device; and
driving said railroad anchor with the first end of the device.
